(19) United States
(12) Patent Application Publication
(10) Pub. No.: US 2012/0072307 A1
(43) Pub. Date: Mar. 22, 2012

(54) PROVIDING A MARKETPLACE FOR SOFTWARE SERVICES

(76) Inventors: Farhang Kassaei, San Jose, CA (US); Senthil Kumar Kandaswamy, San Jose, CA (US)

(21) Appl. No.: 13/236,511

(22) Filed: Sep. 19, 2011

Related U.S. Application Data
(60) Provisional application No. 61/384,803, filed on Sep. 21, 2010.

(51) Int. Cl. G06Q 30/06; G06F 15/177

(52) U.S. Cl. 705/26.41; 709/201; 705/26.1

(57) ABSTRACT

A marketplace machine may provide a marketplace for the software service developed by a developer. The marketplace machine may register a software service, configure a server to provide the software service, and advertise the software service to potential consumers (e.g., other developers). The marketplace machine may receive a request (e.g., a call) to invoke the software service, route the request to a server configured to provide the software service, and record (e.g., meter) the usage of the software service. When the software service is invoked by a consumer, the marketplace machine may charge the consumer a fee for usage of the software service. Furthermore, the marketplace machine may generate and provide a report that indicates usage of the software service.

### RELATED APPLICATIONS

This application claims the priority benefit of U.S. Provisional Patent Application No. 61/384,803, filed Sep. 21, 2010 and entitled “Marketplace for Third-Party Services,” which is incorporated herein by reference in its entirety.

### TECHNICAL FIELD

The subject matter disclosed herein generally relates to the processing of data. Specifically, the present disclosure addresses systems and methods to facilitate provision of a marketplace for software services.

### BACKGROUND

In the context of software, a service (e.g., a software service) may be offered or provided by a server (e.g., as implemented by one or more machines). A software service may be invoked (e.g., by a client device) to cause the server to perform one or more operations of the software service. For example, a database server (e.g., of a shoe seller) may offer a data retrieval service and may accordingly respond to a data retrieval request (e.g., a request for the number of shoes in inventory) by retrieving and returning data (e.g., the number of shoes in the inventory) from a database that is managed by the database server (e.g., a database of inventory records).

Commonly, a software service may have an application programming interface (API) for invoking the software service. A software service may be invoked by a software request (e.g., a “call” to the software service). Different software services may have different APIs. Moreover, a software service may be developed by a developer of the software service, and a different software service may be developed by a different developer. A developer of the software service may be a person or company that generated (e.g., wrote) software that, when hosted (e.g., executed or implemented) by a server, causes the server to offer or provide the software service.

In the context of commerce, a product may be manufactured by a manufacturer and available for purchase from a seller. For example, the product may take the form of a good (e.g., a physical object), a commercial service (e.g., performed by a commercial service provider), information (e.g., digital media), a license (e.g., authorization to access something), or any suitable combination thereof. An item may be a specimen (e.g., an individual instance) of the product, and multiple items may constitute multiple specimens of the product. Accordingly, a seller of a product may seek to merchandise one or more items as specimens of the product.

In merchandising an item, the seller may use a network-based system to present the item to a user of the network-based system (e.g., a potential buyer of the item). Examples of network-based systems include commerce systems (e.g., shopping websites), publication systems (e.g., classified advertisement websites), listing systems (e.g., auction websites), and transaction systems (e.g., payment websites). The item may be presented within a document (e.g., a webpage) that describes the item or product. In shopping for an item, one or more users may search the network-based system (e.g., by submitting queries) for such documents or similar information regarding details of the item or product.

### BRIEF DESCRIPTION OF THE DRAWINGS

Some embodiments are illustrated by way of example and not limitation in the figures of the accompanying drawings.

FIG. 1 is a network diagram illustrating a network environment suitable for providing a marketplace for software services, according to some example embodiments.

FIG. 2 is a block diagram illustrating components of a marketplace machine, according to some example embodiments.

FIG. 3 is a block diagram illustrating data structures within registration data of a software service, according to some example embodiments.

FIG. 4 is a flowchart illustrating interactions among developer devices and the marketplace machine, according to some example embodiments.

FIG. 5 is a flowchart illustrating interactions among a developer device, a marketplace machine, and a server, according to some example embodiments.

FIG. 6-7 are flowcharts illustrating operations in a method of providing a marketplace for software services, according to some example embodiments.

FIG. 8-9 are flowcharts illustrating operations in a method of providing a marketplace for software services, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to providing a marketplace for software services. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A marketplace machine may provide a marketplace for one or more software services developed by one or more developers. The marketplace machine may form all or part of a software service marketplace system that is configured to register a software service (e.g., from a developer), configure one or more servers to host (e.g., provide) the software service, and expose (e.g., merchandise) the software service to potential consumers (e.g., other developers). Moreover, the marketplace machine may form all or part of a software service marketplace system that is configured to receive a request (e.g., a call) to invoke the software service, route the request to a server configured to provide the software service, and record (e.g., meter) the usage of the software service. According to various example embodiments, when the software service is invoked by a consumer of the software service (e.g., one of the other developers), the marketplace machine may charge the consumer a fee for usage of the software service. Furthermore, the marketplace machine may generate and provide a report that indicates usage of the software service (e.g., to the consumer, or to the developer of the software service).

Once developed by a developer, a software service may be useful to other developers of software applications or other software services, and the developer of one software service may wish to merchandise and sell usage (e.g., invocations) of that software service to other developers. Examples of software services include a software service that creates a listing for a product or an item within an electronic marketplace, a software service that accesses all items listed in a category of an electronic marketplace and aggregates an average selling price or velocity for the items, and a software service that accesses all items listed in an electronic marketplace that are listed as being in a particular location and aggregate average selling price or velocity for the items. Another example of the software service is a software service that calculates a number of items in a category that are sold by a seller, checks a quantity of the items in inventory, and orders more items if the number in the inventory goes below a threshold quantity. A further example of the software service is a software service that accesses databases of an electronic marketplace and analyzes a trend for a particular item identified by a universal product code (UPC).

According to various example embodiments, registration, configuration, and advertising of a software service (e.g., an API) may be performed by the marketplace machine before runtime of a software application that uses the software service (e.g., before invocation of the software service) or before runtime of another software service that uses the software service. To register the software service, the marketplace machine may receive registration information that describes the software service (e.g., scope, name, namespace, description, metadata, and one or more endpoints). The registration information may include metadata such as caching information, security information (e.g., public availability, restricted availability, or excluded availability), pricing information (e.g., free, a fee for a time period, a fee per operation, fee per unique operation, or negotiated price or flat fee), quality of service (QoS) information (e.g., low latency or high latency), or any suitable combination thereof. The registration data may specify a single endpoint (e.g., a production server) or multiple endpoints (e.g., a production server and a sandbox server).

According to various example embodiments, invocation of the software service is performed by the marketplace machine at runtime and may include receiving and routing a request to invoke software service, as well as performing a security check (e.g., for access to the software service). During or after runtime, the marketplace machine may track usage of the software service (e.g., use of the software service, use of operations offered by the software service, use of unique operations offered by the software service, use of the software service in a period of time, or use of the software service at a particular QoS level).

During or after runtime, the marketplace machine may charge a fee for usage of the software service (e.g., based on tracked usage). The fee may include a service charge (e.g., for operations performed by the marketplace machine). The marketplace machine may receive the fee from a customer (e.g., calling entity) of the software service, and at least a portion of the fee may be paid to the developer (e.g., selling entity) of the software service.

During or after runtime, the marketplace machine may provide one or more reports that indicate usage, fees, or both, for a particular software service. A report may aggregate the usage of a particular software service (e.g., by operation or by unique operation). A report may be generated for a customer of the software service (e.g., indicating aggregate consumption of various software services, total cost per period of time, cost per developer, cost per software service, errors per software service, and QoS compliance). A report may be generated for a seller of the software service (e.g., indicating revenue and profitability per software service, revenue and profitability per customer, errors per software service, and QoS compliance).

In some example embodiments, the marketplace machine facilitates data enrichment for the server configured to host the software service. After a result of the operation of the software service is provided to a device that requested invocation of the software service, that device may provide generated data to the marketplace machine, to the server, or to both. In response, the marketplace machine may modify a fee charged for use of the software service (e.g., by applying a discount). Accordingly, various example embodiments enable a customer of the software service to pay for its use with money, information, or any suitable combination thereof.

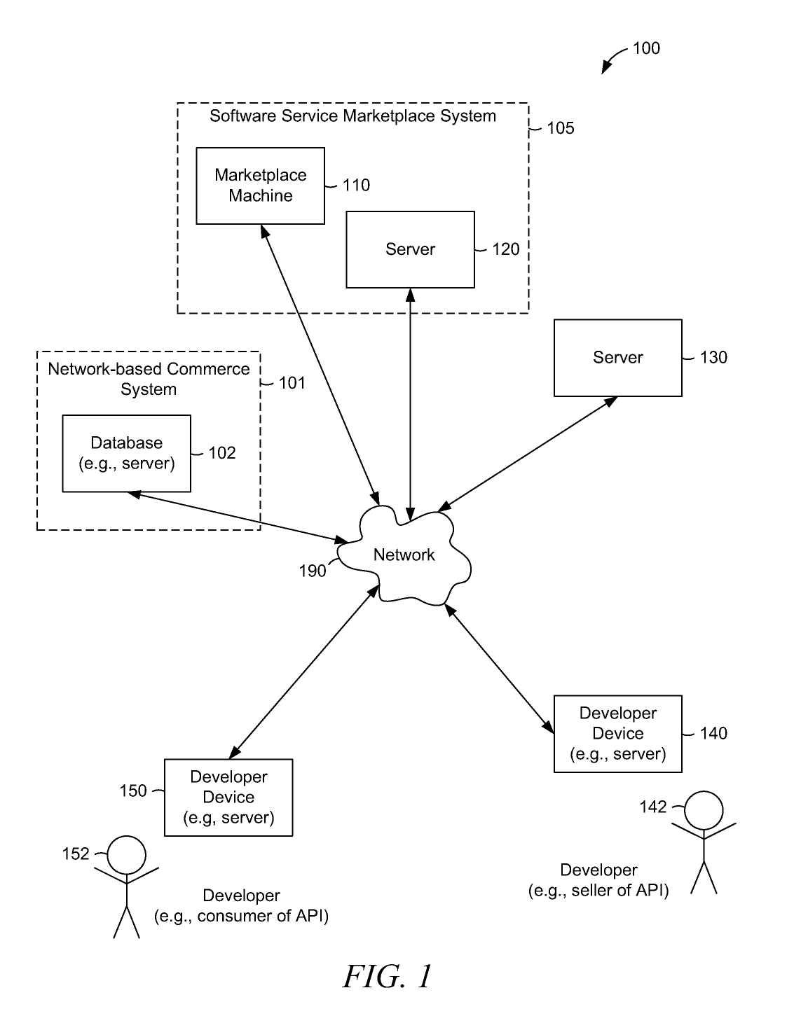

FIG. 1 is a network diagram illustrating a network environment 100 suitable for providing a marketplace for software services, according to some example embodiments. The network environment 100 includes a database 102, a marketplace machine 110, servers 120 and 130, and developer devices 140 and 150, all communicatively coupled to each other via a network 190. As shown, the database 102 may form all or part of a network-based commerce system 101 (e.g., a shopping website). Similarly, the marketplace machine 110 and the server 120 may form all or part of a software service marketplace system 105. Accordingly, the server 120 may be considered internal to the software service marketplace system 105. In contrast, the server 130 may be considered external to the software service marketplace system 105. For example, the server 130 may correspond to a third-party entity (e.g., a person or business) that makes the server 130 available for use with the software service marketplace system 105. Each of the servers 120 and 130 are configurable to host (e.g., offer, provide, implement, execute, or perform one or more operations of) a software service or multiple software services.

The network-based commerce system 101 is shown as an example of a network-based system having a database (e.g., database 102) that may be available for access through performance of an operation of a software service (e.g., by the server 120 or the server 130). For example, the network-based commerce system 101 may maintain a shopping website (e.g., an electronic storefront), and the database 102 may be a data repository (e.g., database server) that stores information (e.g., records) pertaining to items or products sold or available for-sale by the shopping website.

Also shown in FIG. 1 are developers 142 and 152. The developer 142 may be a developer of the software service who is also a seller of the software service (e.g., a provider or seller of an API for the software service). The developer 152 may be a developer of a different software service who is also a potential consumer of the software service developed by the developer 142. For example, the developer 152 may be a consumer or buyer of the API for the software service developed by the developer 142. One or both of the developers 142 and 152 may be a human (e.g., a human being), a machine (e.g., a software program configured to interact with the developer device 140), or any suitable combination thereof (e.g., a human assisted by a machine or a machine supervised by a human). The developer 142 is not part of the network environment 100, but is associated with the developer device 140 and may be a user of the developer device 140. For example, the developer device 140 may be a deskside computer, a tablet computer, or a smart phone belonging to the developer 142. Similarly, the developer 152 is not part of the network environment 100, but is associated with the developer device 150 and may be a user of the developer device 150. As an example, the developer device 150 may be a tablet computer belonging to the developer 152.

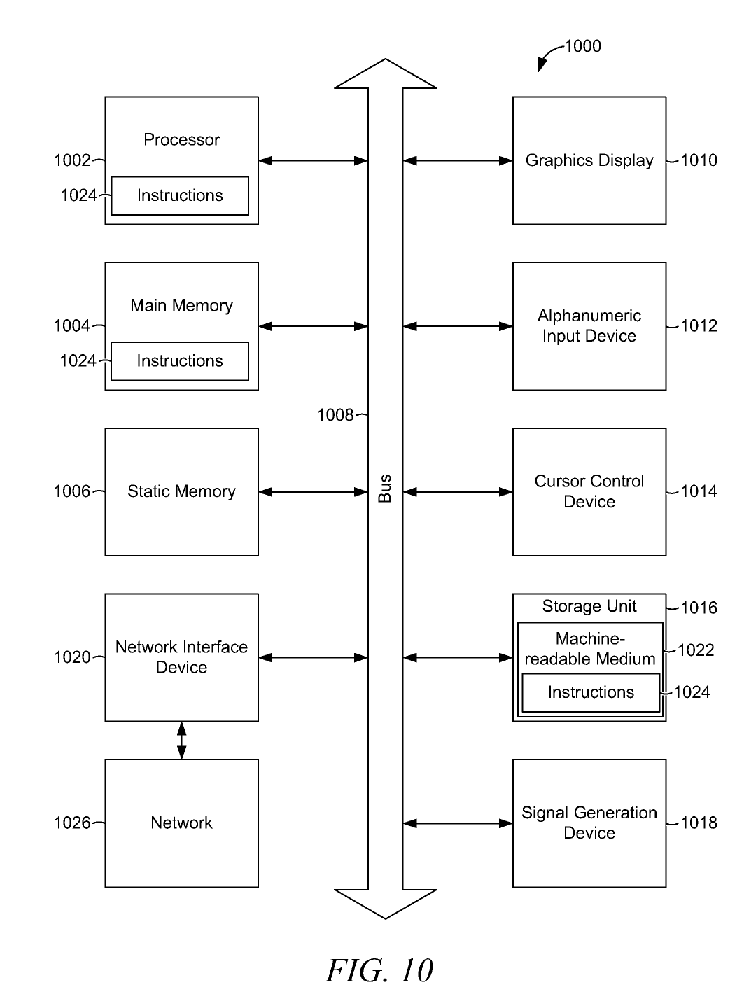

Any of the machines, servers, databases, or devices shown in FIG. 1 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 10. As used herein, a “database” is a data storage resource and may store data structured as a text file, a table, a spreadsheet, a relational database, a triple store, or any suitable combination thereof. Moreover, where suitable, any two or more of the machines illustrated in FIG. 1 may be combined into a single machine, and the functions described herein for any single machine may be subdivided among multiple machines.

The network 190 may be any network that enables communication between machines (e.g., marketplace machine 110 and the developer device 140). Accordingly, the network 190 may be a wired network, a wireless network (e.g., a mobile network), or any suitable combination thereof. The network 190 may include one or more portions that constitute a private network, a public network (e.g., the Internet), or any suitable combination thereof.

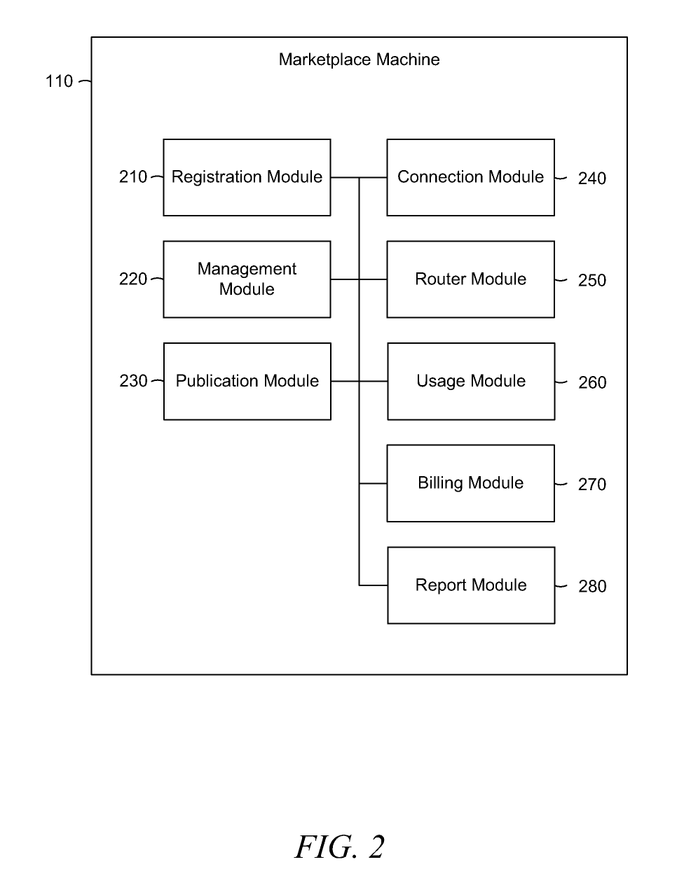

FIG. 2 is a block diagram illustrating components of the marketplace machine 110, according some example embodiments. The marketplace machine 110 includes a registration module 210, a management module 220, a publication module 230, a connection module 240, a router module 250, a usage module 260, a billing module 270, and a report module 280, all configured to communicate with each other (e.g., via a bus, shared memory, or a switch). Any one or more of the modules described herein may be implemented using hardware (e.g., a processor of a machine) or a combination of hardware and software. Moreover, any two or more of these modules may be combined into a single module, and the functions described herein for a single module may be subdivided among multiple modules.

The registration module 210 is configured to receive registration data that describes a software service developed by the developer 142. The software service is configured to cause a server (e.g., server 120 or server 130) to perform an operation (e.g., among multiple available operations) of the software service in response to an invocation of the software service (e.g., through use of an API of the software service). Accordingly, the software service, when hosted by a server, causes the server to perform the operation in response to the invocation of the software service (e.g., through use of the API). The registration module 210 may receive the registration data from the developer device 140.

The management module 220 is configured to configure a server (e.g., server 120 or server 130) to host the software service based on the registration data received by the registration module 210. When configured by the management module 220, the server is configured to respond to a request for the invocation of the software service (e.g., through use of the API).

In some example embodiments, the management module 220 configures the server to host multiple software services (e.g., a set of software services) that include the software service developed by the developer 142. In certain example embodiments, the server 120 is or includes a host machine that is within the software service marketplace system 105, and the management module 220 configures the server 120 to host the software service. In various example embodiments, the server 130 is or includes a host machine that is external to the software service marketplace system 105, and the management module 220 configures the server 130 to host the software service. According to some example embodiments, the developer device 140 is configurable as a host machine (e.g., external to the software service marketplace system 105), and the management module 220 configures the developer device 140 to host the software service.

The publication module 230 is configured to provide a notification that the software service is available for invocation (e.g., through use of the API). The notification may be provided to the developer device 140, the developer device 150, or any combination thereof (e.g., a broadcast message to multiple developer devices). In some example embodiments, the publication module 230 provides a search result that includes at least some of the registration data that describes the software service. For example, the providing of the notification may include providing the search result, and the search results may include or be provided with a portion of the registration data received by the registration module 210. In certain example embodiments, the publication module 230 receives a query to identify the software service among multiple software services available for invocation, and the providing of the notification may be with the search result and in response to the received query.

In some example embodiments, the registration data received by the registration module 210 includes security data that indicates a degree of availability corresponding to the software service, and the publication module 230 may provide the notification based on the degree of availability indicated by the security data. In certain example embodiments, the registration data received by the registration module 210 includes price data that indicates a fee, where the fee is chargeable for the invocation of the software service, and the publication module 230 may provide an indication that the fee is chargeable for the invocation of the software service. For example, the publication module 230 may provide the notification that the software service is available by providing the indication that the fee is chargeable for the invocation. In various example embodiments, the registration data includes service quality data that indicates a latency of the software service in responding to the request for the invocation of the software service, and the publication module 230 may provide an indication of the latency of the software service in responding to the request. As an example, the publication module 230 may provide the notification that the software service is available by providing the indication of the latency of the software service.

The connection module 240 is configured to receive a request (e.g., an API call) for an invocation of the software service developed by the developer 142. The invocation may be requested (e.g., by the developer device 150) through use of an API of the software service (e.g., by using the API call as all or part of the request). For example, the request may be received from the device 150 of the developer 152 (e.g., as a consumer of the software service developed by the developer 142). The software service may be hosted by a server (e.g., server 120, server 130, or developer device 140) that is configured to perform an operation of the software service in response to the invocation of the software service (e.g., through use of the API).

The router module 250 is configured to route the request for the invocation of the software service to the server (e.g., server 120, server 130, or developer device 140) that is configured to perform the operation of the software service in response to the invocation of the software service (e.g., through use of the API). For example, where the management module 220 configured the server 120 to perform the operation of the software service, the router module 250 may route the request for invocation of the software service to the server 120. As noted above, the server 120 may be or include a host machine that is within the software service marketplace system 105. As another example, where the management module 220 configured the server 130 to perform the operation, the router module 250 may route the request to the server 130. As noted above, the server 130 may be or include a host machine that is external to the software service marketplace system 105. As a further example, where the management module 220 configured the developer device 140 to perform the operation, the router module 250 may route the request to the developer device 140. As noted above, the developer device 140 may be configurable as a host machine (e.g., external to the software service marketplace system 105). In some example embodiments, the management module 220 maintains a database (e.g., a look-up table) from which the router module 250 determines the server to which the request is to be routed.

In some example embodiments, the router module 250 determines that the software service is available to the developer 152 (e.g., as a consumer of the software service), and the router module 250 may route the request to the server based on (e.g., in response to) the determining that the software service is available to the developer 152.

The usage module 260 is configured to store a record of the operation of the software service being performed by the server to which the request was routed by the connection module 240. For example, the server 120 may perform the operation in response to the invocation of the software service (e.g., requested through use of the API), and the usage module 260 may store a record of the operation being performed by the server 120 in response to the requested invocation of the software service. As another example, the server 130 may perform the operation, and the usage module 260 may store a record of the operation being performed by the server 130 in response to the requested invocation. As a further example, the developer device 140 may perform the operation, and the usage module 260 may store a record of the operation being performed by the developer device 140 in response to the requested invocation.

In some example embodiments, the usage module 260 stores a count of invocations of the software service. The storing of the count of invocations may be included in the storing of the record of the operation. For example, the usage module 260 may store the record of the operation being performed by storing a count of invocations that indicates a number of times that the developer 152 (e.g., as a consumer of the software service) has invoked the software service.

In certain example embodiments, the usage module 260 stores a count of performances of the operation by the server to which the request was routed by the connection module 240. The storing of the count of performances may be included in the storing of the record of the operation. For example, the usage module 260 may store the record of the operation being performed by storing a count of performances that indicates a number of times that the server 120 performed the operation or a number of times that the server 120 performed the operation in response to invocations of the software service that are requested by the developer 152 (e.g., as a consumer of the software service). As another example, the count of performances may indicate a number of times that the server 130 performed the operation or a number of times that the server 130 performed the operation in response to invocations of the software service that are requested by the developer 152 (e.g., as a consumer of the software service).

The billing module 270 is configured to charge a fee (e.g., to the developer 152 as a consumer of the software service) for performance of the operation by the server to which the request was routed by the connection module 240. The fee may be charged based on (e.g., in response to) the invocation of the software service, which may be requested by the developer 152 (e.g., as a consumer of the software service, it's API, or both).

In some example embodiments, the billing module 270 charges the fee based on a count of invocations of the software service. For example, the billing module 270 may charge the fee to the developer 152 (e.g., as a consumer of the software service) based on a count of invocations stored by the usage module 260 (e.g., a number of times that the developer 152 has invoked the software service).

In certain example embodiments, the billing module 270 charges a fee based on a count of performances of the operation by a particular server or by a particular server in response to invocations of the software service requested by a particular consumer. For example, the billing module 270 may charge the fee to the developer 152 (e.g., as a consumer of the software service) based on a count of performances stored by the usage module 260 (e.g., a number of times that the server 120 performed the operation, a number of times that the server 130 performed the operation in response to invocations of the software service requested by the developer 152, a number of times that the device 140 performed the operation, or any suitable combination thereof).

The report module 280 is configured to provide a report that indicates that the operation is performed by the server to which the request was routed by the connection module 240. The report may be provided to the developer 142 of the software service (e.g., by providing the report to the developer device 140), to the developer 152 who requested (e.g., as a consumer of the software service) the invocation of the software service (e.g., by providing the reports to the developer device 150), or any suitable combination thereof. Moreover, the report may be provided based on (e.g., in response to) the invocation of the software service (e.g., requested through use of the API).

In some example embodiments, the report module 280 provides a report that indicates a number of times that the software service has been invoked (e.g., by the developer 152, as a consumer of the software service). For example, the report module 280 may include a count of invocations (e.g., stored by the usage module 260, used by the billing module 270 in charging a fee, or both) that indicates a number of times that the software service has been invoked (e.g., by the developer 152). Accordingly, the report indicates the number of times that the developer 152 has invoked the software service developed by the developer 142.

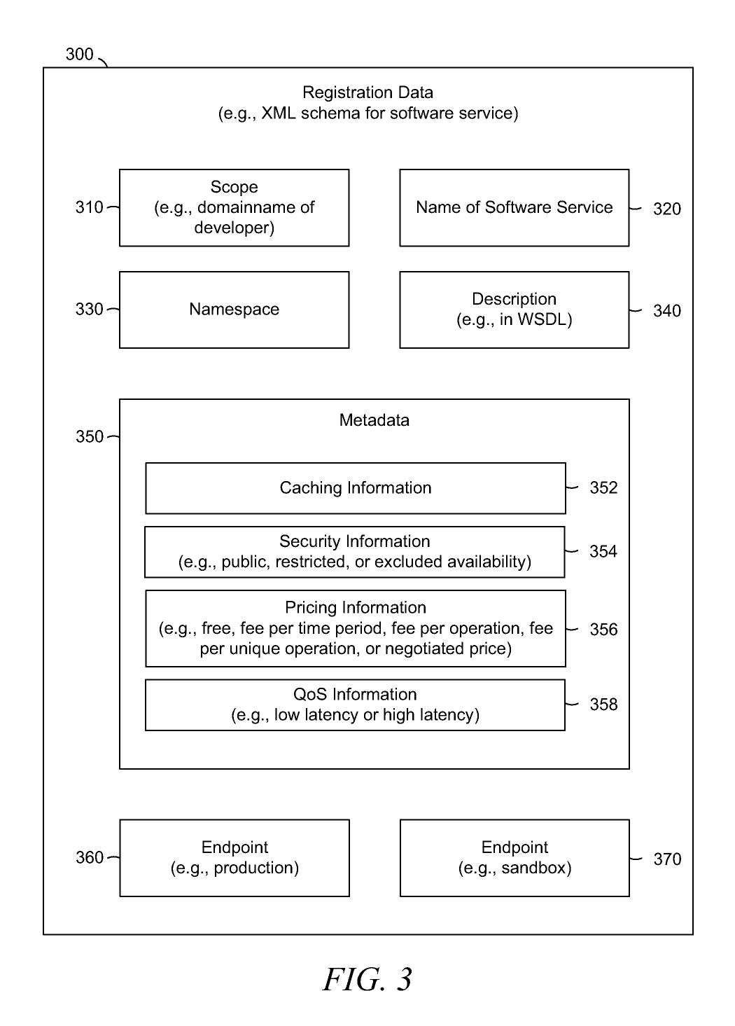

FIG. 3 is a block diagram illustrating data structures within registration data 300 of a software service, according to some example embodiments. The registration data 300 describes a software service, and the registration data 300, or a similar data structure, may be received by the registration module 210, as described above with respect to FIG. 2. The registration data 300 may be or include a schema that describes the software service developed by the developer 142. Such a schema may be expressed (e.g., written) using extensible markup language (XML) or any other suitable language for describing a software service.

The registration data 300 may include a scope 310. The scope 310 may be a domainname (e.g., of the developer 142 who developed the software service).

The registration data 300 may include a name of the software service 320. The name of the software service 320 may be a text string (e.g., generated by the developer 142 who developed the software service).

The registration data 300 may include a namespace 330 of the software service. The namespace 330 may specify a context of the software service (e.g., a context for one or more identifiers used by the software service).

The registration data 300 may include a description 340 of the software service. All or part of the description 340 may be specified by (e.g., written in) Web Services Description Language (WSDL) (e.g., WSDL 1.1).

The registration data 300 may include metadata 350 of the software service. The metadata 350 may include caching information 352 (e.g., parameters specifying how software or data is to be cached). The metadata 350 may include security information 354 (e.g., public availability, restricted availability, or excluded availability). For example, the security information 354 may indicate that one or more operations of the software service, or the software service itself, is available to any calling entity (e.g., public availability), available only to a restricted list of calling entities (e.g., restricted availability), available to any calling entity except entities on a excluded list (e.g., excluded availability), or any suitable combination thereof. The developer 152 (e.g., as a consumer of the software service) may be an example of a calling entity.

The metadata 350 may include pricing information 356 of the software service. The pricing information 356 may indicate whether any fees are to be charged for usage of the software service (e.g., through its API) and may describe how such fees are to be calculated. For example, the pricing information 356 may indicate that the software service may be used for free or that a consumer of the software service (e.g., developer 152) may be charged a fee for a particular time period (e.g., per hour, per day, per month, or per year), charged a fee per operation invoked (e.g., successfully invoked and performed without error), charged a fee per unique operation invoked, charged a flat fee, or any suitable combination thereof.

The metadata 350 may include QoS information 358 of the software service. The QoS information 358 may indicate what quality of service (e.g., what level of quality) is to be provided in response to an invocation of the software service (e.g., through its API). For example, the QoS information 358 may specify that the software service is to be provided with low latency, average latency, or high latency (e.g., between invocation of the software service and performance of an operation of the software service). In some example embodiments, the QoS information 358 is combined or correlated with the pricing information 356 so that one schedule of fees is applicable to one QoS level (e.g., higher fees for lower latencies), while another schedule of fees is applicable to another QoS level (e.g., lower fees for higher latencies).

The registration data 300 may include endpoints 360 and 370. Each of the endpoints 360 and 370 specifies a destination (e.g., as requested during registration of the software service or as selected by the developer 142) to which requests to invoke the software service are to be routed. An endpoint (e.g., endpoint 360) may specify one or more parameters or conditions for routing the request to the destination, in addition to specifying the destination itself. For example, the endpoint 360 may specify a production server (e.g., server 130 or developer device 140) for handling commercial operations or transactions, and the endpoint 370 may specify a sandbox (e.g., testing or experimental) server for handling simulated operations or transactions. In some example embodiments, the endpoint 360 is specified without the endpoint 370. In certain example embodiments, more than two endpoints are specified.

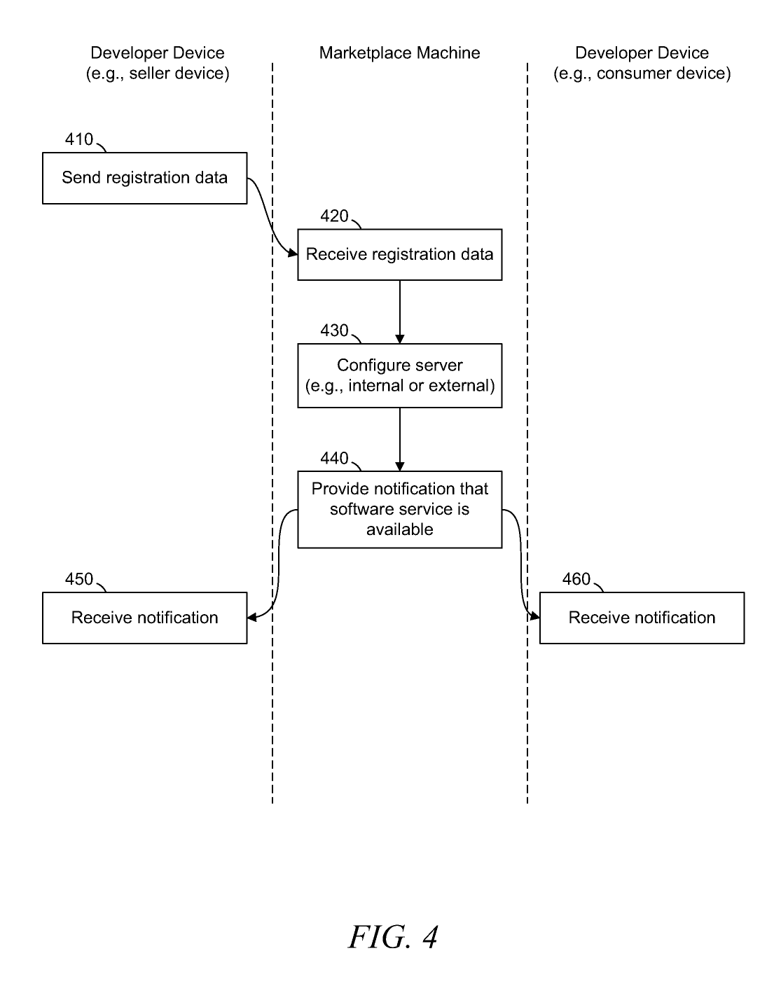

FIG. 4 is a flowchart illustrating interactions among developer devices 140 and 150 and the marketplace machine 110, according to some example embodiments. The interactions shown in FIG. 4 may occur prior to runtime of a software application or software service that uses the software service developed by the developer 142.

In operation 410, the developer device 140 sends registration data 300 to the marketplace machine 110. As noted above, the registration data 300 may describe the software service developed by the developer 142. In operation 420, the marketplace machine 110 receives the registration data 300 from the developer device 140. In operation 430, the marketplace machine 110 configures a server (e.g., server 120, server 130, or developer device 140) to host the software service described by the registration data 300.

In operation 440, the marketplace machine 110 provides a notification that the software service described by the registration data 300 is available for use (e.g., invocation). This notification may be provided to the developer device 140 (e.g., to notify the developer 142 that the software service is now registered and available for invocation by customers), to the developer device 150 (e.g., to notify the developer 152 that the software service is available for use in a software application or a further software service), or to both. In operation 450, the developer device 140 receives the notification from the marketplace machine 110. Similarly, in operation 460, the developer device 150 receives a notification from the marketplace machine 110.

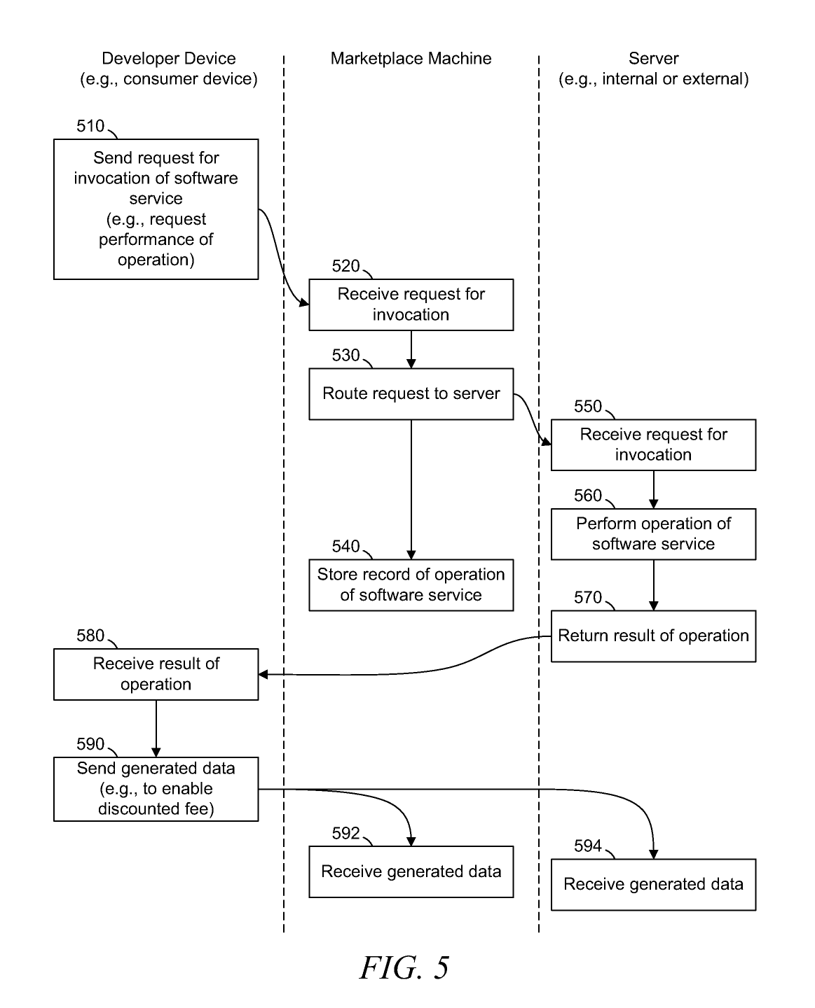

FIG. 5 is a flowchart illustrating interactions among the developer device 150, the marketplace machine 110, and a server (e.g., server 120, server 130, or the developer device 140), according to some example embodiments. Any one or more of operations 510, 520, 530, 540, 550, 560, 570, and 580 may occur during runtime of a software application or software service that uses the software service developed by the developer 142. Any one or more of operations 590, 592, and 594 may occur during or after this runtime.

In operation 510, the developer device 150 (e.g., as a consumer device) sends a request for invocation of the software service described by the registration data 300. The request may be sent to the marketplace machine 110, and the request may be or include a request for performance of operation of the software service. In operation 520, the marketplace machine 110 receives the request from the developer device 150. In operation 530, the marketplace machine 110 routes the request for invocation of the software service to the server that is configured to host the software service (e.g., server 120, server 130, or the developer device 140).

In operation 550, the server (e.g., server 120, server 130, or the developer device 140) receives the request for invocation of the software service. In operation 560, the server performs an operation of the software service (e.g., as requested by the request for invocation of the software service). For example, the server may perform the operation by accessing the database 102 within the network-based commerce system 101 and retrieving or modifying a data record stored in the database 102.

In operation 570, the server returns a result of the operation (e.g., to the developer device 150 that sent the request for invocation of the software service). For example, the server may provide a data record retrieved from the database 102. As another example, the server may provide a confirmation that a data record in the database 102 has been successfully retrieved or modified. In some example embodiments, the server returns the results to the developer device 150, while in other example embodiments, the server returns the results to the marketplace machine 110 (e.g., via the router module 250), which routes the results to the developer device 150.

In operation 540, the marketplace machine 110 stores a record of the operation being performed by the server. In operation 580, the developer device 150 (e.g., as a consumer device) receives the result of the operation, as sent from the server (e.g., server 120, server 130, or developer device 140) that performed the operation of the software service.

In some example embodiments, operations 590-594 are performed (e.g., in response to operation 580). In operation 590, the developer device 150 sends generated data to the marketplace machine 110, to the server (e.g., server 120, server 130, or developer device 140) that performed the operation of the software service, or to both. The generated data may include information generated based on the received result of the operation of the software service. This may have the effect of providing a benefit (e.g., access to the generated data) to the marketplace machine 110, the server, or both. In some example embodiments, a fee for use of the software service (e.g., the invoked performance of the operation of the software service) is reduced or discounted in response to the provision of this benefit. In operation 592, the marketplace machine 110 receives the generated data from the developer device 150 (e.g., as a consumer device with respect to the software service). Similarly, in operation 594, the server receives the generated data from the developer device 150 (e.g., as a consumer device with respect to the software service).

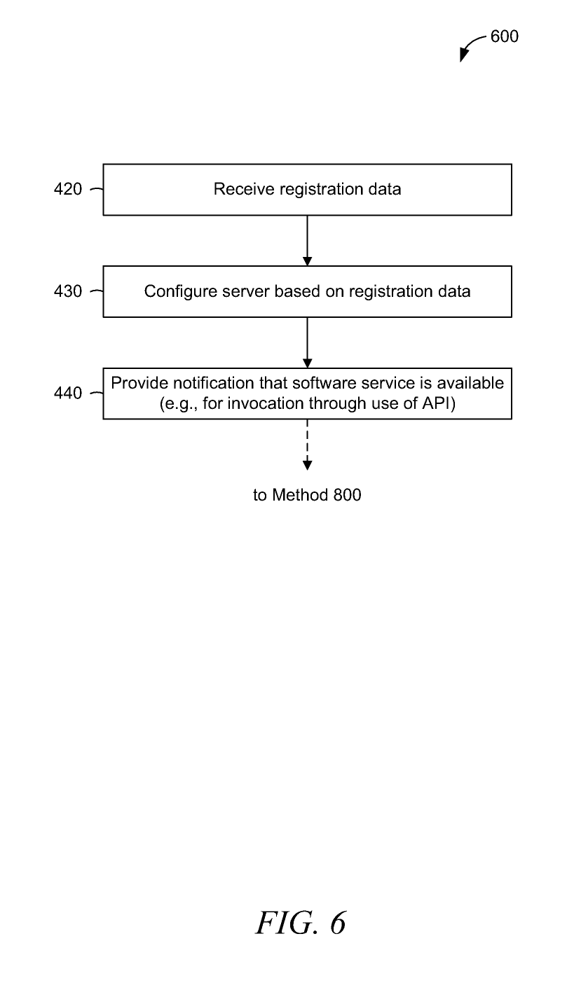

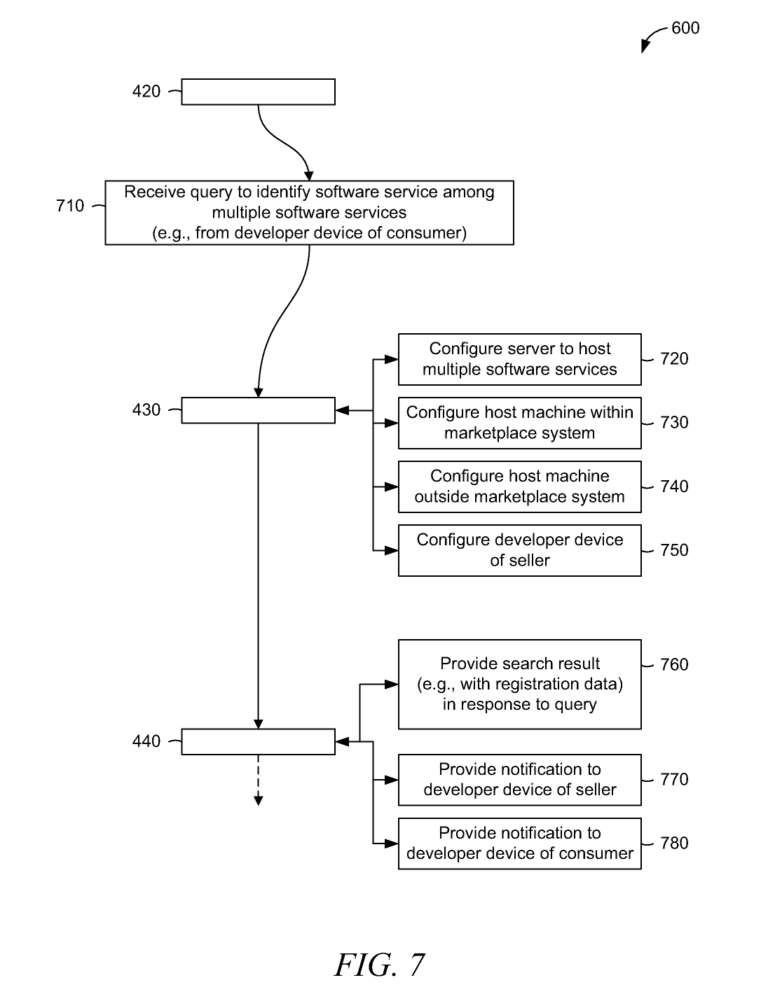

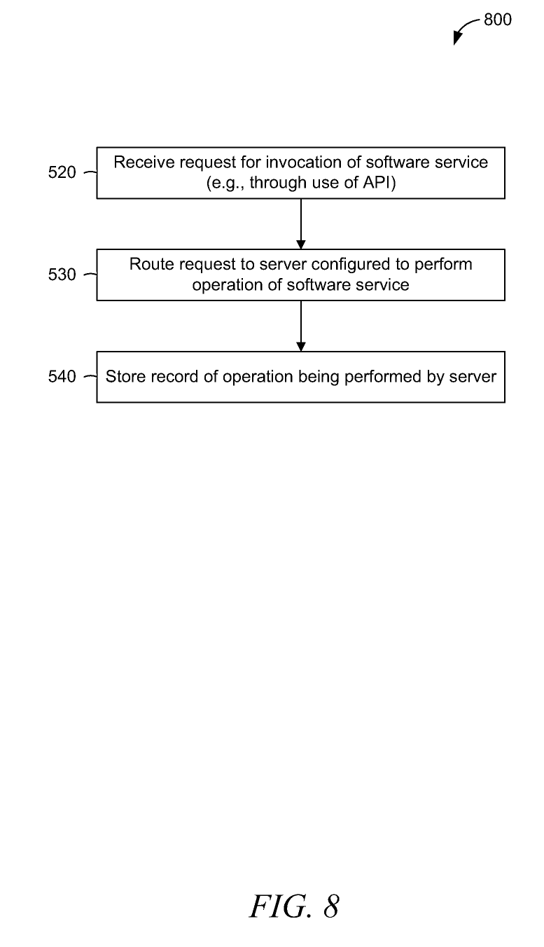

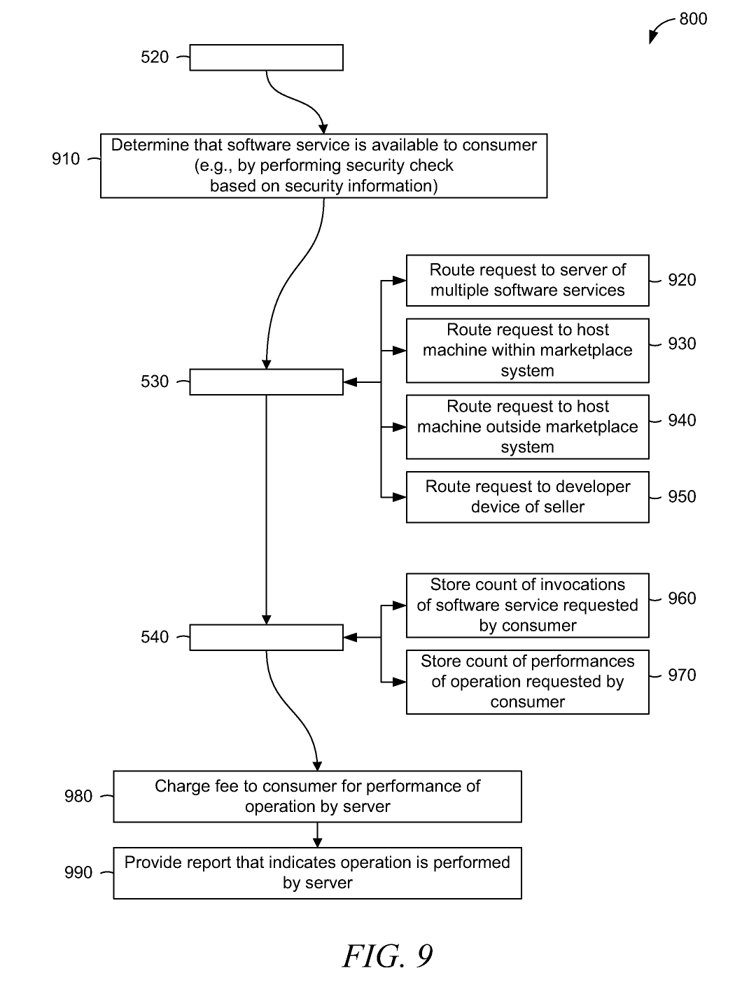

FIG. 6-7 are flowcharts illustrating operations in a method 600 of providing a marketplace for software services, according some example embodiments. Operations in the method 600 may be performed by the marketplace machine 110, using modules described above with respect to FIG. 2. As shown in FIG. 6, the method 600 includes operations 420, 430, and 440, which were briefly described above with respect to FIG. 4. In some example embodiments, the method 600 is combined with one or more additional methods (e.g., as described below with respect to the FIG. 8-9) to provide a marketplace for software services.

In operation 420, the registration module 210 of the marketplace machine 110 receives the registration data 300 for a software service developed by the developer 142. The software service, when hosted by a server, is operable to cause the server to perform an operation of the software service (e.g., in response to an invocation of the software service). For example, the registration data 300 may be submitted by the developer 142 via the developer device 140 to the marketplace machine 110, and the registration module 210 may receive the registration data 300 from the developer device 140.

In operation 430, the management module 220 of the marketplace machine 110 configures a server (e.g., server 120, server 130, or the developer device 140) based on the registration data 300 received in operation 420. The marketplace machine 110 configures the server to host the software service (e.g., by responding to a request for invocation of the software service through use of an API of the software service).

In operation 440, the publication module 230 of the marketplace machine 110 provides a notification that the software service developed by the developer 142 is available for invocation (e.g., through use of an API of the software service). The notification may be provided to the developer device 140, to the developer device 150, or to both. In some example embodiments, the developer device 150 is a device of the developer 152, where the developer 152 is a developer of another software service (e.g., a further software service) that is unable to cause the server to perform the operation of the software service developed by the developer 142. Accordingly, the developer 152 may be a potential consumer (e.g., customer) of the software service developed by the developer 142 and described by the registration data 300.

In some example embodiments, the publication module 230 provides the notification based on the degree of availability indicated by the security information 354 in the registration data 300. For example, the notification may include an indication that the software service is publicly available. As another example, the notification may indicate that the software service is not available to the developer 152 (e.g., as a member of a blacklist of developers). As a further example, the notification may indicate that the software service is available specifically to the developer 152 (e.g., as a member of a white list of developers).

In certain example embodiments, the publication module 230 provides an indication that a fee is chargeable for invocation of the software service. The providing of this indication may be based on the pricing information 356 in the registration data 300. For example, the notification provided by the publication module 230 may include a statement that an invocation of the software service will incur a fee.

In various example embodiments, the publication module 230 provides an indication of a latency of the software service (e.g., expected, predicted, or promised) in responding to a request for invocation of the software service. The providing of this indication may be based on the QoS information 358 in the registration data 300. For example, the notification provided by the publication module 230 may include a statement that a maximum latency of 50 milliseconds (e.g., between invocation of the software service and provision of a result from an operation of the software service) is available for a particular fee, while a maximum latency of 500 milliseconds is available for another fee.

As shown in FIG. 7, the method 600 may include one or more of operations 710, 720, 730, 740, 750, 760, 770, and 780. In operation 710, the publication module 230 of the marketplace machine 110 receives a query to identify the software service described by the registration data 300 among multiple software services available for invocation (e.g., from multiple servers). In some example embodiments, the publication module 230 provides a search engine operable (e.g., by the developer 152) to search among the multiple software services and identify one or more software services that satisfy one or more search criteria. The query received in operation 710 may be answered with a search result, as described below with respect to operation 760.

One or more of operations 720, 730, 740, and 750 may be performed as part (e.g., a precursor task, a subroutine, or a portion) of operation 430, in which the management module 220 configures the server based on the registration data 300 received in operation 420. In operation 720, the management module 220 of the marketplace machine 110 configures the server to host multiple software services, where the multiple software services include the software service described by the registration data 300. For example, the server may have ample computing resources (e.g., processor, memory, storage, or input/output capacity) to host thousands of software services, and the management module 220 may configure the server to host several hundreds of software services. In example embodiments that include operation 720, operation 440 may include identification of the software service described by the registration data 300 among multiple software services or a subset thereof. For example, operation 440, in providing the notification that the software service is available, may identify the software service as one of a dozen software services in the category of “inventory data retrieval” within a marketplace that is offering hundreds of software services.

In operation 730, the management module 220 of the marketplace machine 110 configures the server 120, which is within the software service marketplace system 105, as a host machine for the software service described by the registration data 300. In operation 740, the management module 220 configures the server 130, which is external to the software service marketplace system 105, as a host machine for the software service described by the registration data 300. In operation 750, the management module 220 configures the developer device 140, which may be a device of the developer 142, as a host machine for the software service described by the registration data 300. According to some example embodiments, the management module 220 configures multiple servers (e.g., server 120 and server 130) to facilitate load balancing, redundancy, network traffic management, or any suitable combination thereof.

One or more of operations 760, 770, and 780 may be performed as part (e.g., a precursor task, a subroutine, or a portion) of operation 440, in which the publication module provides the notification that the software service is available. In operation 760, the publication module 230 provides a search result that includes at least some of the registration data 300 that describes the software service developed by the developer 142. For example, the publication module 230 may provide the notification by providing the search result. The providing of the search result may be in response to the receiving of the query in operation 710.

In operation 770, the publication module 230 provides the notification to the developer device 140, which may be a device of the developer 142 that developed the software service described by the registration data 300. In operation 780, the publication module 230 provides the notification to the developer device 150, which may be a device of the developer 152 (e.g., a consumer or customer of the software service).

FIG. 8-9 are flowcharts illustrating operations in a method 800 of providing a marketplace for software services, according to some example embodiments. As shown in FIG. 8, the method 800 includes operations 520, 530, and 540, which were briefly described above with respect to FIG. 5. In some example embodiments, the method 800 is combined with one or more additional methods (e.g., method 600) to provide a marketplace for software services.

In operation 520, the connection module 240 of the marketplace machine 110 receives a request (e.g., a call to an API) for an invocation of the software service developed by the developer 142 and described by the registration data 300. For example, the invocation may be requested through use of an API of the software service, and the software service may be hosted by a server (e.g., server 120, server 130, or the developer device 140) that is configured (e.g., by the management module 220 of the marketplace machine 110) to perform an operation of the software service in response to the invocation of the software service. As noted above, the request may be received from the developer device 150, which may be a device of the developer 152 (e.g., a consumer of the software service or its API).

In operation 530, the router module 250 of the marketplace machine 110 routes (e.g., communicates) the request for the invocation of the software service to the server (e.g., server 120, server 130, or the developer device 140) that is configured to perform the operation of the software service. As noted above, the server receives the request, performs the operation, and returns a result of the operation (e.g., to the marketplace machine, to the developer device 150, or both).

In operation 540, the usage module 260 of the marketplace machine 110 stores a record of the operation of the software service as being performed (e.g., having been performed) by the server to which the request for the invocation was routed. As noted above, the server may have performed the operation in response to the invocation of the software service, as requested through use of the API of the software service. The usage module 260, in performing operation 540, may track the usage of the software service (e.g., use of the software service, use of operations offered by the software service, use of unique operations offered by the software service, use of the software service in a period of time, or use of the software service at a particular QoS level).

As shown in FIG. 9, the method 800 may include one or more of operations 910, 920, 930, 940, 950, 960, 970, 980, and 990. In operation 910, the router module 250 of the marketplace machine 110 determines that the software service is available to the developer 152 (e.g., as a consumer of the software service). This determination may be made based on the security information 354 in the registration data 300, which was received by the marketplace machine 110 (e.g., via the registration module 210). In example embodiments that include operation 910, the router module 250 may perform operation 530 based on the determination performed that the software service is available to the developer 152.

One or more of operations 920, 930, 940, and 950 may be performed as part (e.g., a precursor task, a subroutine, or a portion) of operation 530, in which the router module 250 of the marketplace machine 110 routes the request for invocation of the software service. In operation 920, the router module 250 routes the request to a server that is configured (e.g., by the management module 220) to host multiple software services, where the multiple software services include the software service described by the registration data 300. For example, the router module 250 may route the request to a server configured to host hundreds of software services, including the software service developed by the developer 142.

In operation 930, the router module 250 routes the request for the invocation of the software service to the server 120, which is within the software service marketplace system 105 and may be configured (e.g., by the management module 220) as a host machine for the software service described by the registration data 300. In operation 940, the router module 250 routes the request for the invocation to the server 130, which is external to the software marketplace system 105 and may be configured as a host machine for the software service. In operation 950 the router module 250 routes the request to the developer device 140, which may be a device of the developer 142 and may be configured as a host machine for the software service. According to some example embodiments, the router module 250 routes the request to multiple servers (e.g., server 120 and server 130), and the multiple servers determine (e.g., by executing an arbitration algorithm) which particular server will perform the operation requested by the request for the invocation of the software service.

One or more of operations 960 and 970 may be performed as part (e.g., a precursor task, a subroutine, or a portion) of operation 540, in which the usage module 260 of the marketplace machine 110 stores a record of the requested operation being performed by the server that is hosting the software service. In operation 960, the usage module 260 of the marketplace machine 110 stores a count of invocations of the software service. For example, the usage module 260 may store a number of times that the developer 152 (e.g., as a consumer of the software service) invoked the software service (e.g., total invocations of the software service, total invocations of any operation of the software service, total invocations of a particular operation of the software service, total invocations within a period of time, or total invocations at a particular QoS level).

In operation 970, the usage module 260 of the marketplace machine 110 stores a count of performances of the operation by the server that is hosting the software service. For example, the usage module 260 may store a number of times the server performed the operation in response to one or more invocations of the software service requested by the developer 152 (e.g., as a consumer of the software service).

One or more of operations 980 and 990 may be performed after operation 540, in which the usage module 260 of the marketplace machine 110 stores the record of the operation being performed. In operation 980, the billing module 270 of the marketplace machine 110 charges a fee to the developer 152 (e.g., as a consumer of the software service). The fee may be charged for performance of the operation by the server in response to the invocation of the software service in response to the request received in operation 520. In some example embodiments, the billing module 270 charges the fee based on the count of invocations stored by the usage module 260 in operation 960. In certain example embodiments, the billing module 270 charges the fee based on the count of performances stored by the usage module 260 in operation 970.

As noted above, the fee charged by the billing module 270 may include a service charge (e.g., for operations performed by the marketplace machine). In some example embodiments, the billing module 270 may receive the fee from the developer 152 (e.g., via the developer device 150). In certain example embodiments, at least a portion of the fee may be paid by the billing module 270 to the developer 142 (e.g., via the developer device 140) of the software service.

In operation 990, the report module 280 of the marketplace machine 110 provides a report that indicates that the operation is performed (e.g., has been performed) by the server (e.g., server 120, server 130, or the developer device 140) configured to host the software service. As noted above, the server may have performed the operation in response to the invocation of the software service requested by the request (e.g., an API call) received in operation 520. In some example embodiments, the report module 280 provides a report that indicates a number of times that the developer 152 (e.g., as a consumer of the software service) invoked the software service (e.g., the count of invocations stored by the usage module 260 in operation 960). In certain example embodiments, the report module 280 provides a report that indicates a number of times that the server performed the operation in response to one or more invocations of the software service requested by the developer 152 (e.g., as a consumer of the software service).

As noted above, the report may aggregate the usage of a particular software service (e.g., by operation or by unique operation). The report may indicate invocations of multiple software services by the developer 152 (e.g., indicating aggregate consumption of various software services, total cost per period of time, cost per developer, cost per software service, errors per software service, and QoS compliance). The report may indicate invocations of multiple software services merchandised by the developer 142 (e.g., indicating revenue and profitability per software service, revenue and profitability per customer, errors per software service, and QoS compliance).

According to various example embodiments, one or more of the methodologies described herein may facilitate provision of a marketplace for one or more software services. In particular, one or more of the methodologies described herein may facilitate aggregation of software services, registration of software services, and configuration of one or more servers to host software services, as well as exposure (e.g., merchandising) of software services to potential customers. Additionally, one or more of the methodologies described herein may facilitate reception and routing of requests to invoke software services, as well as tracking performance of operations of the software services, reporting performance of those operations, and charging fees for performance of those operations. Moreover, one or more of the methodologies described herein may constitute all or part of a business method (e.g., a business method implemented using a machine) that provides, operates, and maintains a marketplace for software services.

When these effects are considered in aggregate, one or more of the methodologies described herein may obviate a need for certain efforts or resources that otherwise would be involved in matching developers (e.g., as potential sellers and consumers of software services) with each other. Efforts expended by a developer in identifying a suitable software service (e.g., with acceptable fees and latencies) may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 illustrates components of a machine 1000, according to some example embodiments, that is able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system and within which instructions 1024 (e.g., software) for causing the machine 1000 to perform any one or more of the methodologies discussed herein may be executed. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a peer-to-peer (or distributed) network environment. The machine 1000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1024 (sequentially or otherwise) that specify actions to be taken by that machine. Further, while only a single machine is illustrated, the term “machine” shall also be taken to include a collection of machines that individually or jointly execute the instructions 1024 to perform any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The machine 1000 may further include a graphics display 1010 (e.g., a plasma display panel (PDP), a liquid crystal display (LCD), a projector, or a cathode ray tube (CRT)). The machine 1000 may also include an alphanumeric input device 1012 (e.g., a keyboard), a cursor control device 1014 (e.g., a mouse, a touchpad, a trackball, a joystick, a motion sensor, or other pointing instrument), a storage unit 1016, a signal generation device 1018 (e.g., a speaker), and a network interface device 1020.

The storage unit 1016 includes a machine-readable medium 1022 on which is stored the instructions 1024 (e.g., software) embodying any one or more of the methodologies or functions described herein. The instructions 1024 may also reside, completely or at least partially, within the main memory 1004, within the processor 1002 (e.g., within the processor's cache memory), or both, during execution thereof by the machine 1000. Accordingly, the main memory 1004 and the processor 1002 may be considered as machine-readable media. The instructions 1024 may be transmitted or received over a network 1026 (e.g., network 190) via the network interface device 1020.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions (e.g., instructions 1024). The term “machine-readable medium” shall also be taken to include any medium that is capable of storing instructions (e.g., software) for execution by the machine, such that the instructions, when executed by one or more processors of the machine (e.g., processor 1002), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving registration data that describes a software service developed by a developer,
the software service, when hosted by a server, causing the server to perform an operation of the software service in response to an invocation of the software service through use of an application programming interface (API) of the software service,
the receiving of the registration data being from a device of the developer that developed the software service;
configuring the server to host the software service based on the registration data that describes the software service,
the server being configured to respond to a request for the invocation of the software service through use of the API of the software service,
the configuring of the server being performed by a processor of a machine; and
providing a notification that the software service is available for invocation through use of the API.

2. The method of claim 1, wherein:
the providing of the notification includes providing the notification to a further device of a further developer of a further software service,
the further software service being unable to cause the server to perform the operation,
the further developer being a potential consumer of the software service described by the registration data.

3. The method of claim 1, wherein:
the providing of the notification includes providing a search result that includes at least some of the registration data that describes the software service.

4. The method of claim 3, further comprising:
receiving a query to identify the software service among multiple software services available for invocation; and wherein
the providing of the search result that includes at least some of the registration data is in response to the receiving of the query to identify the software service.

5. The method of claim 1 wherein:
the configuring of the server configures the server to host a plurality of software services that includes the software service; and
the providing of the notification identifies the software service among the plurality of software services.

6. The method of claim 1, wherein:
the configuring of the server includes configuring a host machine that is within a marketplace system configured to implement a marketplace of software services.

7. The method of claim 1, wherein:
the configuring of the server includes configuring a host machine that is external to a marketplace system configured to implement a marketplace of software services.

8. The method of claim 1, wherein:
the configuring of the server includes configuring the device of the developer that developed the software service.

9. The method of claim 1, wherein:
the registration data includes security data that indicates a degree of availability that corresponds to the software service; and
the providing of the notification is based on the degree of availability indicated by the security data.

10. The method of claim 1, wherein:
the registration data includes price data that indicates a fee chargeable for the invocation of the software service; and
the providing of the notification includes providing an indication that the fee is chargeable for the invocation of the software service.

11. The method of claim 1, wherein:
the registration data includes service quality data that indicates a latency of the software service in responding to the request for the invocation of the software service; and
the providing of the notification includes providing an indication of the latency of the software service in responding to the request.

12. A system comprising
a registration module configured to receive registration data that describes a software service developed by a developer,
the software service, when hosted by a server, causing the server to perform an operation of the software service in response to an invocation of the software service through use of an application programming interface (API) of the software service,
the receiving of the registration data being from a device of the developer that developed the software service;
a processor configured by a management module that configures the processor to configure the server to host the software service based on the registration data that describes the software service,
the server being configured to respond to a request for the invocation of the software service through use of the API of the software service; and
a publication module configured to provide a notification that the software service is available for invocation through use of the API.

13. The system of claim 12, wherein:
the publication module is configured to provide the notification by providing the notification to a further device of a further developer of a further software service,
the further software service being unable to cause the server to perform the operation,
the further developer being a potential consumer of the software service described by the registration data.

14. The system of claim 12, wherein:
the management module configures the processor to configure the server by configuring the device of the developer that developed the software service.

15. The system of claim 12, wherein:
the registration data includes security data that indicates a degree of availability that corresponds to the software service; and
the publication module is configured to provide the notification based on the degree of availability indicated by the security data.

16. The system of claim 12, wherein:
the registration data includes price data that indicates a fee chargeable for the invocation of the software service; and
the publication module is configured to provide the notification with an indication that that the fee is chargeable for the invocation of the software service.

17. The system of claim 12, wherein:
the registration data includes service quality data that indicates a latency of the software service in responding to the request for the invocation of the software service; and
the publication module is configured to provide the notification with an indication of the latency of the software service in responding to the request.

18. A non-transitory machine-readable storage medium comprising instructions that, when executed by one or more processors of a machine, cause the machine to perform operations comprising:
receiving registration data that describes a software service developed by a developer,
the software service, when hosted by a server, causing the server to perform an operation of the software service in response to an invocation of the software service through use of an application programming interface (API) of the software service,
the receiving of the registration data being from a device of the developer that developed the software service;
configuring the server to host the software service based on the registration data that describes the software service,
the server being configured to respond to a request for the invocation of the software service through use of the API of the software service,
the configuring of the server being performed by the one or more processors of the machine; and
providing a notification that the software service is available for invocation through use of the API.

19. The non-transitory machine-readable storage medium of claim 18, wherein:
the providing of the notification includes providing the notification to a further device of a further developer of a further software service,
the further software service being unable to cause the server to perform the operation,
the further developer being a potential consumer of the software service described by the registration data.

20. A system comprising:
means for receiving registration data that describes a software service developed by a developer,
the software service, when hosted by a server, causing the server to perform an operation of the software service in response to an invocation of the software service through use of an application programming interface (API) of the software service,
the receiving of the registration data being from a device of the developer that developed the software service;
means for configuring the server to host the software service based on the registration data that describes the software service,
the server being configured to respond to a request for the invocation of the software service through use of the API of the software service; and
means for providing a notification that the software service is available for invocation through use of the API.

21. A method comprising:
receiving a request for an invocation of a software service developed by a developer,
the invocation being requested through use of an application program interface (API) of the software service,
the software service being hosted by a server configured to perform an operation of the software service in response to the invocation of the software service through use of the API,
the receiving of the request being from a device of a consumer of the software service;
routing the request for the invocation of the software service to the server configured to perform the operation of the software service,
the routing of the request being performed by a processor of a machine; and
storing a record of the operation of the software service being performed by the server,
the operation being performed in response to the invocation of the software service requested through use of the API.

22. The method of claim 21, wherein:
the routing of the request to the server includes routing the request to a host machine that is within a marketplace system configured to implement a marketplace of software services.

23. The method of claim 21, wherein:
the routing of the request to the server includes routing the request to a host machine that is external to a marketplace system configured to implement a marketplace of software services.

24. The method of claim 21, wherein:
the routing of the request to the server includes routing the request to a device of the developer that developed the software service.

25. The method of claim 21 further comprising:
determining that the software service is available to the consumer of the software service; and wherein
the routing of the request to the server is responsive to the determining that the software service is available to the consumer.

26. The method of claim 21, further comprising:
charging a fee to the consumer for performance of the operation by the server in response to the invocation of the software service requested by the consumer.

27. The method of claim 21, further comprising:
providing a report that indicates that the operation is performed by the server in response to the invocation of the software service requested by the consumer.

28. The method of claim 21, wherein:
the storing of the record of the operation includes storing a count of invocations of the software service,
the count of invocations indicating a number of times the consumer invoked the software service.

29. The method of claim 28, further comprising:
charging a fee to the consumer based on the count of invocations that indicates the number of times the consumer invoked the software service.

30. The method of claim 28, further comprising:
providing a report that indicates the number of times the consumer invoked the software service.

31. The method of claim 21, wherein
the storing of the record of the operation includes storing a count of performances of the operation by the server,
the count of performances indicating a number of times the server performed the operation in response to invocations of the software service requested by the consumer.

32. The method of claim 31 further comprising:
charging a fee to the consumer based on the count of performances that indicates the number of times the server performed the operation in response to invocations of the software service requested by the consumer.

33. The method of claim 31 further comprising:
providing a report that indicates the number of times the server performed the operation in response to invocations of the software service requested by the consumer.

34. A system comprising:
a connection module configured to receive a request for an invocation of a software service developed by a developer,
the invocation being requested through use of an application program interface (API) of the software service,
the software service being hosted by a server configured to perform an operation of the software service in response to the invocation of the software service through use of the API,
the receiving of the request being from a device of a consumer of the software service;
a processor configured by a router module that configures the processor to route the request for the invocation of the software service to the server configured to perform the operation of the software service; and
a usage module configured to store a record of the operation of the software service being performed by the server,
the operation being performed in response to the invocation of the software service requested through use of the API.

35. The system of claim 34 further comprising:
a billing module configured to charge a fee to the consumer for performance of the operation by the server in response to the invocation of the software service requested by the consumer.

36. The system of claim 34 further comprising:
a report module configured to provide a report that indicates that the operation is performed by the server in response to the invocation of the software service requested by the consumer.

37. A non-transitory machine-readable storage medium comprising instructions that, when executed by one or more processors of a machine, cause the machine to perform operations comprising:
receiving a request for an invocation of a software service developed by a developer,
the invocation being requested through use of an application program interface (API) of the software service,
the software service being hosted by a server configured to perform an operation of the software service in response to the invocation of the software service through use of the API,
the receiving of the request being from a device of a consumer of the software service;
routing the request for the invocation of the software service to the server configured to perform the operation of the software service,
the routing of the request being performed by the one or more processors of the machine; and
storing a record of the operation of the software service being performed by the server,
the operation being performed in response to the invocation of the software service requested through use of the API.

38. The non-transitory machine-readable storage medium of claim 37, wherein:
the routing of the request to the server includes routing the request to a device of the developer that developed the software service.

39. A system comprising:
means for receiving a request for an invocation of a software service developed by a developer,
the invocation being requested through use of an application program interface (API) of the software service,
the software service being hosted by a server configured to perform an operation of the software service in response to the invocation of the software service through use of the API,
the receiving of the request being from a device of a consumer of the software service;
means for routing the request for the invocation of the software service to the server configured to perform the operation of the software service; and
means for storing a record of the operation of the software service being performed by the server,
the operation being performed in response to the invocation of the software service requested through use of the API.
